(19) United States
(12) Patent Application Publication
(10) Pub. No.: US 2025/0262934 A1
(43) Pub. Date: Aug. 21, 2025

(54) METHOD AND CONTROL DEVICE FOR INVOKING FUNCTIONS AND FOR ACTIVATING SETTINGS OF A VEHICLE

(71) Applicant: Peter BONGERS, Cortona (IT)

(72) Inventor: Peter BONGERS, Cortona (IT)

(21) Appl. No.: 18/859,719

(22) PCT Filed: Apr. 28, 2023
(86) PCT No.: PCT/EP2023/061303

§ 371 Date: Oct. 24, 2024

(30) Foreign Application Priority Data
Apr. 29, 2022 (DE) 10 2022 110 485.0

(51) Int. Cl. B60K 35/10; B60K 35/23; G06F 3/0354

(52) U.S. Cl. CPC B60K 35/10; B60K 35/23; G06F 3/03543; B60K 2360/135; B60K 2360/1434

(57) ABSTRACT

A human-machine for calling up functions and for actuating settings of a vehicle, the functions and the settings being represented by elements in a display area which is located in the field of vision of a person operating the vehicle. An input marker in the display region can be moved by an input device which is to be intuitively operated by the operator, for example, a touchpad or a joystick, or a mouse, onto the element of a function or onto the element of a setting to be activated.

The invention relates to a computer-assisted method and a computer-assisted control system for invoking functions and for activating settings of a vehicle, also referred to as a “computer-assisted human-machine user interface” or “Human Machine Interface (HMI)”.

Safely driving a vehicle requires from a person driving the vehicle—referred to in short as a person hereinafter—full attentiveness during the observation of the traffic scenario.

Not least to increase the driving comfort and in particular the driving safety, vehicles have computer-assisted control systems having a large functional scope. Designing these control systems so that their functional scope is expandable is already known. For this purpose, it may be provided for the control system to have access to networked services.

In addition to the vehicle-typical functions, service and business activities can be offered via the control systems, such as parking, shopping, and overnight stay options. The variety of offers is nearly unlimited and will expand in future.

Vehicles also regularly have a variety of setting options presently. Settings of steering, motor, braking, and chassis characteristics and in particular of safety and warning functions are mentioned as examples. Moreover, vehicles regularly have high-quality multimedia devices, which enable settings of their sound to the listening habits of the person or of passengers.

Due to the variety of functions and setting options, which is becoming larger and larger, invoking all functions and activating all settings using conventional means activatable without eye contact by the person, such as stalk switches, steering wheel buttons, etc., is no longer possible. The HMIs used in current vehicles regularly comprise input means which require the eye contact of the person for activation. In this way, they are distracted from the observation of the traffic scenario. A significant increase of the risk of a traffic accident is linked thereto.

This risk exists all the more as functions are regularly to be invoked in different ways in various vehicles and this is in turn different from how any settings of the vehicle are activated. Thus, some vehicles comprise both mechanical switches for invoking functions and also rotating knobs for activating settings of the vehicle. Due to the variety of functions and setting options, these switches and rotating knobs are then assigned to various functions and settings, for which purpose, for example, touchscreens are provided. In particular in the case of the latter—in contrast to a switch or rotating knob—usually no haptic sensing of an operating element is possible, so that the view of the person always has to be directed to the touchscreen at the moment of use. Time spans in which the person is no longer looking at the traffic scenario necessarily result in this way.

To provide a remedy here, providing gesture or speech controls for invoking functions and for activating settings of the vehicle is already known. However, it has been shown in practice that the gestures or speech controls often do not function with the desired reliability. In particular, gestures are often not recognized or are misinterpreted by the gesture control and the speech control only functions when the person uses the word selection intended for invoking the respective function or for activating the respective setting in the system. The person is therefore forced to learn the vehicle-specific “commands” if they wish to use the speech control without errors. In order to facilitate the use of the speech control, displaying word sequences recognized by the system for invoking functions and for activating settings in a display is known in some vehicles. However, the person is once again distracted from the traffic events in this way, due to which the risk of accident in turn increases.

Against this background, the invention is based on the object of creating an improved method and an improved control system for invoking functions and for activating settings of a vehicle, in other words an improved HMI of a vehicle, which enables safe driving of the vehicle in spite of the growing functional scope.

The method according to the invention provides displaying at least the functions and settings which cannot be invoked or activated, respectively, using the conventional means activatable without eye contact in a computer-assisted manner, i.e., by way of software by elements in a display area which is located in the field of view of the person driving the vehicle.

In order for the display area to be located in the field of view of the person, its lateral edges have to be in the horizontal viewing angle of the person. The maximum lateral extension of the display area is thus limited by the horizontal viewing angle of the person. This is typically 124°. However, the lateral extension of the display area is preferably selected so that its edges are located within a viewing angle of +/−30° from a forward viewing direction of the person that coincides with a longitudinal axis of the vehicle.

In order for the upper edge of the display area to be located in the field of view of the person, it has to be located in the vertical viewing angle. For this purpose, it is located in a direction offset at most by an angle of 50° from a horizontal viewing direction of the person, preferably at most 25°. The lower edge of the display area is located in a direction offset at most by 70°, preferably by at most 30° from the horizontal viewing direction of the person. It is ensured as a result of these measures that the vehicle driver always has the entire display area and therefore also all elements displayed therein in view, without having to turn away from the traffic scenario for this purpose.

The preferred small angle values specified above for the horizontal and vertical viewing angles delimit an angle range also designated hereinafter as the “optimum viewing angle”.

Furthermore, the method according to the invention provides that the individual elements are selectable using a computer-assisted input mark, i.e. generated by software, also called a “cursor”, in the display area. According to the invention, an input means is provided for moving the input mark, which is activatable by the person intuitively, i.e. solely on the basis of the haptics of the input means and without visual contact.

The elements can therefore be selected using the input means and the functions can be invoked or the settings can be activated without the person having to look away from the traffic scenario for this purpose.

Since the input mark and the elements are generated in a computer-assisted manner by means of software, the design of the input mark and that of the elements as well as their arrangement are adaptable to desires and requirements of, for example, various vehicle producers. The method according to the invention can thus be adapted, for example, to a corporate identity of a vehicle producer. The method according to the invention is therefore universally usable and can also be adapted to future developments of vehicles and future changes of legal provisions by simple software updates.

It is also conceivable to design the method according to the invention or to operate it using software such that different and/or fewer elements are generated in the display area during the operation of the vehicle than during the standstill of the vehicle.

Because of this flexibility of the method according to the invention, it would also be conceivable to provide personalized versions of the software which can then be used in various vehicles. People who regularly drive different vehicles can then access a design of the method preferred by them and adapted to their personal requirements independently of the type or producer of the respective vehicle.

It would also be conceivable to provide a version of the software which standardizes the method according to the invention for specific vehicles, for example, in that the elements are displayed in the display area in a specific defined arrangement in relation to one another. In this case, the person no longer has to adapt to vehicle-specific differences when invoking functions and activating settings of the respective vehicle. The person is therefore also not distracted from the traffic events by differences of the operation when driving various vehicles. The use of this version would be conceivable, for example, in vehicles which are provided for use in so-called “car sharing”, in which people drive different vehicles depending on the spontaneous availability and spontaneous needs.

It is essential, as already explained above, that the display area is located in the field of view of the person driving the vehicle. This can be carried out, for example, by a projection of the display area on at least a part of a windshield or a ground glass screen of the vehicle. It is also conceivable that additionally to the projection, parts of the dashboard of the vehicle which are in the field of view of the person comprise one or more displays that then form at least a part of the display area.

The invention also relates in particular to a control system associated with the HMI for a vehicle for invoking functions and for activating settings of the vehicle, using which the method according to the invention can be carried out. According to the invention, it has a display area which is arranged in the field of view of a person operating the vehicle. The maximum lateral extension of the display area is delimited by the horizontal viewing angle of the vehicle driver. This is typically 124°. Preferably, the lateral extension of the display area is selected so that its edges are located within a viewing angle of +/−30° from a forward viewing direction of the vehicle driver coinciding with a longitudinal axis of the vehicle.

In order that the upper edge of the display area is located in the field of view of the vehicle driver, it is located in a direction offset at most by an angle of 50°, preferably by at most 25° from a horizontal viewing direction of the vehicle driver. The lower edge of the display area is located in a direction offset at most by 70°, preferably by at most 30° from the horizontal viewing direction of the vehicle driver. Due to these measures, it is ensured that the vehicle driver always has the entire display area and therefore also all elements displayed therein in view, without having to turn away from the traffic events.

Furthermore, the control system according to the invention comprises a supervision unit, by means of which elements, which are assigned to the functions and settings, can be generated in a computer-assisted manner in the display area. The supervision unit is designed such that furthermore an input mark, also called a “cursor”, can be generated within the display area in a computer-assisted manner, by means of which the functions are selectable and activatable.

According to the invention, the control system furthermore comprises an input means intuitively activatable by the person driving the vehicle and connected to the supervision unit, using which the input mark is movable in the display area in a computer-assisted manner and the functions can be invoked and the settings can be activated by selecting the corresponding elements.

In one preferred embodiment of the control system, the display device comprises a projection device which interacts with at least a part of a windshield of the vehicle. The projection device can be designed for this purpose, for example, in the manner of a known head-up display.

Alternatively or additionally, the display device can comprise a display which is arranged, for example, in a part of the dashboard of the vehicle located in the field of view of the person operating the vehicle.

Furthermore, it is conceivable to provide additional display devices for passengers which can be used for other purposes independent of the operation of the vehicle. These display devices are then preferably formed separately from the display device for the person driving the vehicle in such a manner that the latter is not distracted by the additional display devices.

The input means can be designed in any arbitrary way which permits intuitive activatability of the input means. “Intuitive activatability” means that the safe activatability of the input means without visual contact of the person driving the vehicle is ensured solely on the basis of their haptic perception. For this purpose, the input means can comprise, for example, a touchpad or a joystick. A touchpad requires the visual attention of the driver, however, in particular the driver has to direct their viewing angle from the traffic events onto the touchpad at least for a brief moment to operate the touchpad. Furthermore, it has to be ensured in the case of a touchpad that during an adjustment by means of pulling a cursor or an electronic slide controller with a fingertip, for example, as in the case of a volume control, the finger or the touch of the finger does not lose the electronic element, such as the controller or cursor. Therefore, such an operation requires increased attentiveness of the driver. The input means therefore particularly preferably comprises a mouse. The invention has recognized that this is particularly suitable for intuitive activatability, even without particular visual attentiveness.

It should be clear that the term mouse is to be understood as an input means fundamentally known for computers. Such an input device is typically enclosed by the hand of the operator and can be laterally offset, in particular pushed, to control a cursor. A laser scanner inside the mouse is preferably used for this purpose, which detects the movement of the mouse via a detection of the underlying surface on which the mouse is moved. Further operating fields can reach the visualized area due to a so-called scroll wheel. A cursor can therefore be moved, for example, on the entire display area in a particularly simple and secure manner and used to select programs or an app.

In one particularly preferred embodiment, the mouse comprises an ergonomically shaped housing for this purpose, which comprises activation means such as buttons and/or a rotating knob. The supervision device is then designed in such a way that by moving the mouse on an underlying surface and/or by scrolling using a rotating knob, the input mark is moved in the display area and by activating the activation means, the desired element is selected and therefore the assigned function is invoked or the assigned setting of the vehicle is activated. The mouse can be wired or wireless.

The mouse and the underlying surface on which it is movable are preferably formed with magnetic means optionally activatable and deactivatable by means of the supervision unit such that the mouse can be held on the underlying surface due to magnetic forces and moved into a starting position. An electromagnetic mousepad can be provided for this purpose. Preferably, an electromagnetic field can be built up from below the mouse or a mouse pad. Preferably, due to a software control of the supervision unit, the magnetic means are activated during the operation of the vehicle so that the mouse can be manually moved on the underlying surface and if needed also lifted off of the underlying surface and—particularly preferably—moved back into a starting location on the underlying surface when it is not manually deflected. For this purpose, the magnetic means—also preferably—can be activated by means of the supervision unit so that they are switched off at the moment when the person driving the vehicle manually activates the mouse. For example, the mouse can be magnetically fixed during the journey at a predefined position and can be free in its movement upon touching or grasping of the mouse due to switching off of the magnetic field. When the mouse is released, for example when the driving situation requires grasping the steering wheel with both hands, the mouse can then be pulled back into the predefined position and held there by the magnetic field, which is then reactivated. The mouse can thus be secured in the event of lateral forces, as during cornering, against slipping down laterally from the underlying surface, in particular the mouse pad. The magnetic holding of the mouse can thus preferably be switched on and off. The mouse preferably has a metal base. It can thus interact particularly effectively with the electromagnetic pad.

The supervision unit is designed or the software running thereon is programmed such that a movement of the input mark on the display area takes place due to a movement of the mouse on the underlying surface.

The underlying surface and a side of the housing of the mouse facing toward the underlying surface are preferably formed flat for this purpose.

The invention also relates to a vehicle having a control system according to the invention.

The invention is to be explained in more detail hereinafter on the basis of the appended drawings. In the figures:

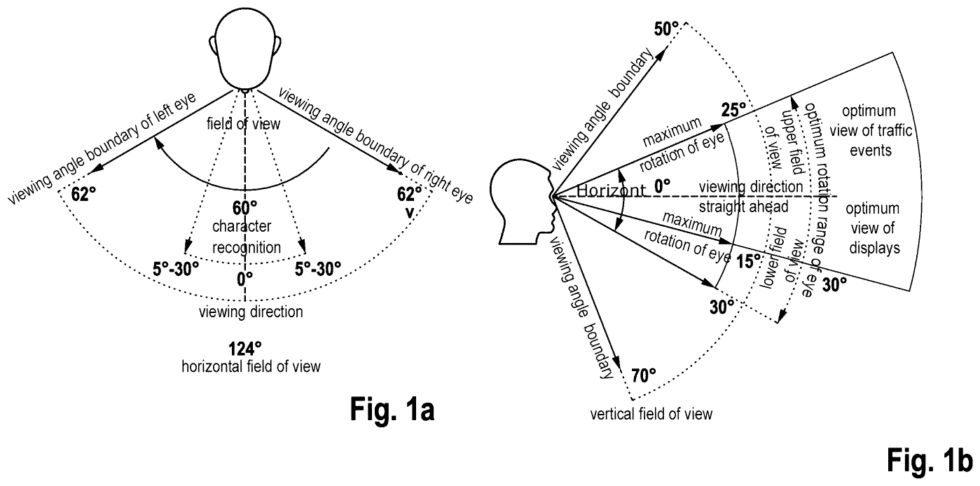

FIG. 1a) shows an illustration of the horizontal field of view of a person driving a vehicle;

FIG. 1b) shows the vertical field of view of a person driving a vehicle;

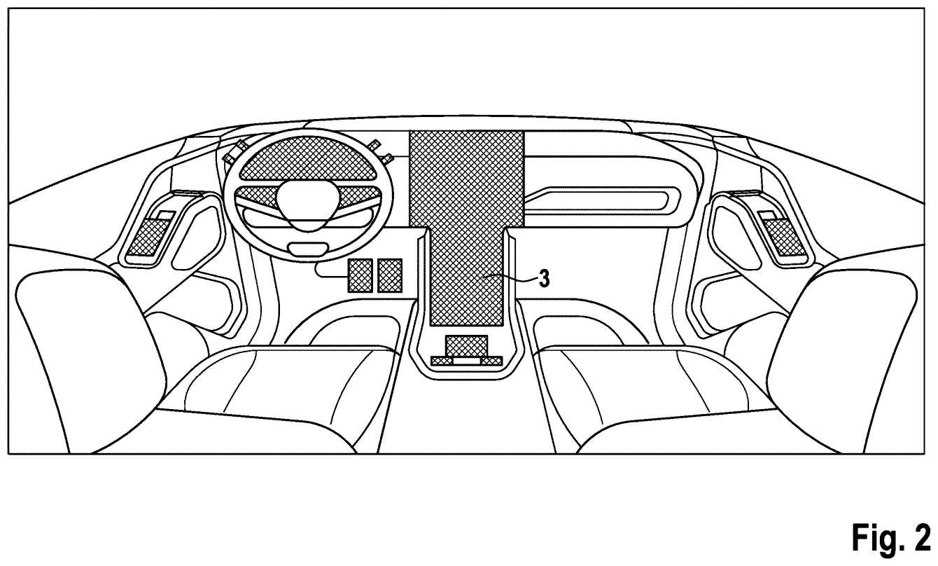

FIG. 2 shows a front area of a passenger compartment of a vehicle, in which areas which are located outside the field of view of a person driving the vehicle, when their viewing direction is directed horizontally forward to observe the traffic events, are represented by crossed lines;

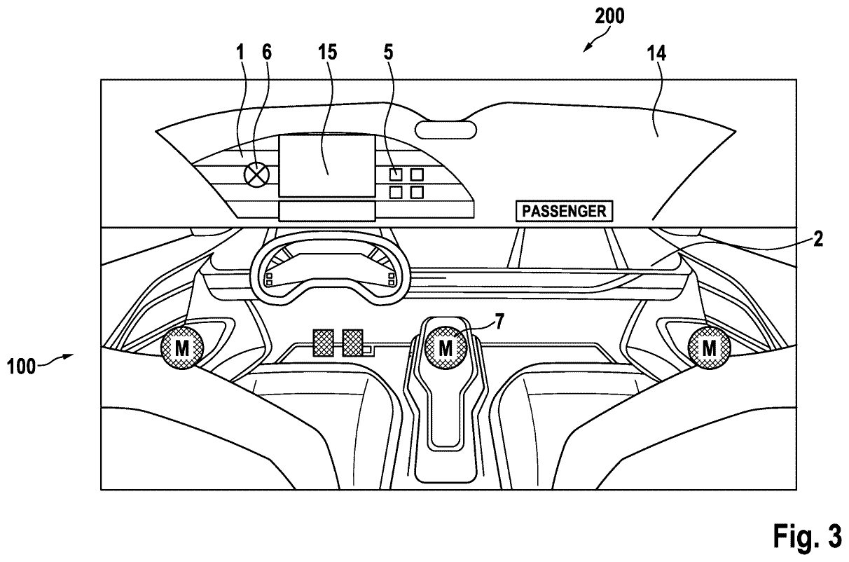

FIG. 3 shows the front part of a passenger compartment of a vehicle, in which areas which are located in the field of view of a person driving the vehicle when their viewing direction is directed horizontally forward to observe the traffic events and which are used to form display areas, for example, are represented by lines, and

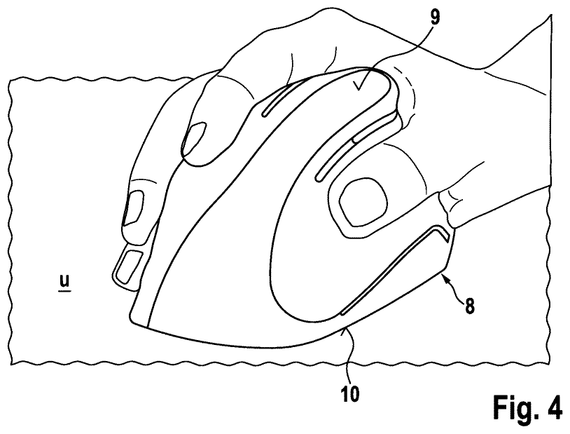

FIG. 4 shows an exemplary embodiment of an intuitively activatable input means.

As is graphically symbolized in FIGS. 1a) and b), the horizontal field of view of a person looking forward in the horizontal direction typically extends over an angle range of 124°. The vertical field of view typically extends over an angle range of 50° upward from the horizontal and over an angle range of 70° downward from the horizontal. A person driving a vehicle can optically perceive events without changing the viewing direction pointing horizontally forward if these events take place in the field of view of the person driving the vehicle. If these events take place outside the field of view, it is thus necessary for the person to change their viewing direction in order to be able to perceive these events.

As is also shown in FIGS. 1a) and 1b), a perceptibility of optical events for a person having a viewing direction pointing horizontally forward is possible in particular if these events are located in a horizontal viewing angle of +/−30° and in a vertical viewing angle of +25° to −15° from the horizontal. The field of view resulting therefrom of a person driving a vehicle is to be designated hereinafter as the “optimum field of view”.

In conventional vehicles, the design of the method or the control system for invoking functions and for activating settings of the vehicle always requires the person driving the vehicle to change their viewing direction. This is the case in particular if display areas in which elements are optically perceptible, which symbolize the functions and settings, are arranged outside the optimum field of view of the person driving the vehicle.

It is accordingly necessary when driving such vehicles for the person to continuously change their viewing direction. The possibility for safe vehicle driving is restricted in this way. For illustration, areas which are not suitable against this background for displaying elements which symbolize functions or settings of the vehicle are represented by crossed lines in FIG. 2. FIG. 2 therefore shows an example from the prior art, in which these display areas are all arranged in a dashboard 2 and in a center console 3 in a passenger compartment 4 of a vehicle.

These crossed-line areas are also not suitable for invoking functions and for activating settings when the corresponding input means have to be optically perceived for this purpose. This is the case, for example, if the input means are symbols displayed on a touchscreen. It is obvious that proven input means such as stalk switches and pedals, which are safely activatable without visual contact, can also be used in the areas represented by crossed lines.

FIG. 3 shows an area of a passenger compartment 4 of a vehicle 100 which is equipped with a control system 200 according to the invention and therefore its functions are invoked and its settings are activatable using the method according to the invention. For this purpose, the functions and settings are symbolized by optically perceptible elements 5 which are displayed in a display area 1 located in the optimum field of view of the person driving the vehicle (not shown in FIG. 3). An input mark 6 is also located in the display area, which is movable with the aid of an input means 7 such that the elements 5 are individually selectable. For this purpose, the input means is designed to be intuitively operable, i.e. without optical contact.

In the illustrated exemplary embodiment, the input means 7 comprises a mouse 8, as shown by way of example in FIG. 4. It comprises an ergonomically designed housing 9, which can be grasped with a hand of the person operating the vehicle without visual contact and the alignment of which is detectable solely on the basis of the haptic perception. In the illustrated exemplary embodiment, the housing 9 of the mouse 8 has a flat lower side 10, which rests on a flat underlying surface 11. The housing 9 and the underlying surface 11 are designed such that the lower side 10 is attracted by the underlying surface by magnetic forces, so that the housing is movable on the flat underlying surface from a starting position, which the mouse 8 assumes due to the magnetic forces.

The mouse 8 additionally has activating means 12 in the form of buttons 13 protruding from the surface of the housing 9. The mouse 8 is functionally integrated into the control system 200 of the vehicle 100 such that a movement of the input mark 6 in the field of view 1 takes place due to a movement on the underlying surface 11, so that the input mark 6 can be moved onto individual elements 5. With the aid of the activating means 12, in the illustrated exemplary embodiment by pressing a button 13, the function or the setting symbolized by the respective element 5 selected with the aid of the input mark 6 can be invoked or activated, respectively.

In the exemplary embodiment of a vehicle 100 according to the invention shown in FIG. 3, the display area 1 extends over a part of a windshield 14 of the vehicle 100. To form at least a part of the display area, the vehicle 100 is designed for this purpose having a corresponding projection device of a known design, also referred to as a head-up display. In addition, the vehicle 100 comprises a display 15 previously known as such. This can be designed such that it forms a part of the display area 1.

### LIST OF REFERENCE NUMERALS

100 vehicle
200 control system
1 display area
2 dashboard
3 center console
4 passenger compartment
5 elements
6 input mark
7 input means
8 mouse
9 housing
10 lower side
11 underlying surface
12 activating means
13 button
14 windshield
15 display

1.-13. (canceled)

14. A method for invoking functions and for activating settings of a vehicle,
wherein the functions and settings are represented by elements in a display area located in the field of view of a person driving the vehicle, and
wherein an input mark is moved in the display area by means of an input means, which is to be operated intuitively by the person operating the vehicle, onto the element of a setting to be activated.

15. The method according to claim 14, wherein at least a part of the display area is effectuated by a projection into a windshield of the vehicle.

16. The method according to claim 14, wherein at least a part of the display area is generated by a representation on a display arranged on a part of a dashboard of the vehicle located in the field of view of the person operating the vehicle.

17. The method according to claim 14, wherein the input means comprises a mouse, and the input mark is produced by means of displacing the mouse.

18. The method according to claim 17, wherein the display area is changeable by means of the mouse, by a scroll wheel.

19. A control system for invoking functions and for activating settings of a vehicle,
having a display area which is arranged in the field of view of a person operating the vehicle,
wherein the display area has elements which are assigned to the functions and settings,
having an input mark within the display area, using which elements are individually actuatable and selectable,
and having an intuitively activatable input means, by means of which the input mark is movable, the functions can be invoked, and the settings are activatable.

20. The control system according to claim 16, wherein the control system comprises a projection device which interacts with at least a part of a windshield of the vehicle.

21. The control system according to claim 19, wherein the control system comprises a display which is arranged in the field of view of the person driving the vehicle and is arranged in a part of a dashboard of the vehicle.

22. The control system according to claim 19, wherein the input means comprise a touchpad or a joystick, or a mouse.

23. The control system according to claim 19, wherein the input means comprise a mouse.

24. The control system according to claim 22, wherein the mouse has an ergonomically shaped housing comprising an actuating means, which is securable via magnetically acting means on an underlying surface against inadvertent lifting off and/or slipping from the underlying surface.

25. The control system according to claim 24, wherein the magnetically acting means are activatable, such that they are activated when the housing of the mouse is not manually activated by an operator.

26. A vehicle having a control system according to claim 19.
